(19) United States
(12) Patent Application Publication
(10) Pub. No.: US 2007/0065092 A1
(43) Pub. Date: Mar. 22, 2007

(54) RECORDABLE DVD STRUCTURE

(75) Inventor: Joseph J. Wrobel, Rochester, NY (US)

Correspondence Address: PATENT LEGAL STAFF, EASTMAN KODAK COMPANY, 343 STATE STREET, ROCHESTER, NY, 14650-2201, US

(73) Assignee: Eastman Kodak Company

(21) Appl. No.: 11/382,493

(22) Filed: May 10, 2006

Related U.S. Application Data
(63) Continuation-in-part of application No. 11/229,269, filed on Sep. 16, 2005.

(51) Int. Cl. H04N 9/88

(52) U.S. Cl. 386/3

(57) ABSTRACT

A structure of a recordable DVD disc is disclosed that permits a second recording event to be recorded and accessed by DVD players that do not recognize multisession media by modifying the value of the Extent Location within the Information Control Block in the VIDEO_TS directory File Identifier Descriptor located in the Root directory of the first track or session to refer to an extent outside the first track or session.

### CROSS REFERENCE TO RELATED APPLICATIONS

This application is a continuation-in-part of U.S. Ser. No. 11/229,269 filed Sep. 16, 2005, entitled “Recordable DVD Structure” by Joseph J. Wrobel. Reference is made to commonly assigned U.S. patent application Ser. No. 11/173,699 filed Jul. 1, 2005, entitled “Recordable DVD Structure” by Joseph J. Wrobel and U.S. patent application Ser. No. 11/229,275, filed Sep. 16, 2005, entitled “Recordable DVD Structure” by Joseph J. Wrobel, the disclosures of which are incorporated herein by reference.

### FIELD OF THE INVENTION

The present invention relates to optical recording discs and, more particularly, to an improved recordable Digital Versatile Disc (DVD) format disc structure.

### BACKGROUND OF THE INVENTION

Recordable DVD format discs are well known in the art. Physical standards for the DVD-R type recordable DVD format disc are available from the DVD Format/Logo Licensing Corporation. Physical standards for the DVD+R type recordable DVD format disc are available from the Intellectual Property & Standards group of the Philips Corporation.

In addition there are logical standards for the arrangement of data on the discs. The file structure on DVD media is typically compliant with the Universal Data Format (UDF) Specification defined and maintained by the Optical Storage Technology Association (OSTA). The UDF specification is a specific embodiment of the ISO/IEC 13346 standard (and the equivalent publication ECMA-167) entitled “Volume and File Structure of Write-Once and Rewritable Media using Non-Sequential Recording for Information Interchange”. UDF 1.02 requires that all DVD-Video discs shall be mastered to contain all required data as specified by ISO 13346 and UDF.

In practice, most DVD media also incorporate the file structure specified by the International Standards Organization (ISO) 9660 standard (“Information processing—Volume and file structure of CD-ROM for information interchange”). If a disc contains both UDF and ISO 9660 file systems, then it is known as a UDF Bridge disc. According to the UDF version 2.50 document, consumer DVD players shall only support UDF and not ISO 9660. However, the presence of the ISO 9660 file structure on a DVD disc does not degrade its playability in a consumer DVD player.

The UDF standard applies to both forms of DVD media, ROM and recordable. The most recent version supports multisession recording. Multisession recording is important for write-once media such as DVD-R and DVD+R because it allows a user to add additional information to the disc over time. If a new recording event is done in accordance with the appropriate specifications, then a multisession capable DVD player will be able to read all of the information recorded to the disc in all of the sessions.

Multisession recording is beneficial because given the substantial capacity of the DVD format, it is often the case that a disc is written well short of its capacity, and a user would benefit by adding more information at a later time. Multisession recording also finds use in applications in which a first session is recorded with generic content, for example software, and a second session is added with user specific data. An example of such a disc would be an imaging application in which the first session contained image display software and the second session contained images belonging to the end user. The recordable DVD disc bearing the first session software could be sold to the public who could then add their images in a second session to be viewed using the software in the first session.

A multisession disc is closed to further append when a new session is written to the disc with the stipulation that it be the last session. This last session could contain new content or it could be a “dummy” session, i.e. session with no new content. In any case, the disc is finalized, i.e. put in a condition that allows no further additional sessions.

Unfortunately, although there are benefits to multisession DVD discs, the majority of the installed base of consumer DVD players are not multisession capable. They are produced to meet version 1.02 of the UDF specification that was issued before the process for multisession recording was defined in that specification. If a multisession disc is placed into a DVD player that is not multisession capable, the DVD player will only allow access to information stored in the first track of the first session; any subsequent information added to the disc is unknown to the DVD player and will be inaccessible to the user.

When a disc is mounted in a DVD player, the DVD player first establishes that the disc is recorded in accordance with the UDF specification. It does this by reading a series of sectors from the disc from the region defined by the UDF specification as the volume recognition area. If the disc complies with the UDF specification, the DVD player will find a series of volume structure descriptors in a volume recognition sequence that is unique to a UDF compliant disc.

Once a disc is established as UDF compliant, the DVD player then reads a data sector at one of the anchor points defined in the UDF specification. This sector will contain the Anchor Volume Descriptor Pointer. Within the Anchor Volume Descriptor Pointer, the DVD player will find the extents of the Main and Reserve Volume Descriptor Sequences recorded on the disc. The Volume Descriptor Sequence contains all the information needed for the drive to access information recorded on the disc including file and directory names, locations and sizes.

For a multisession disc, a new Anchor Volume Descriptor Pointer is written at the anchor points within each newly recorded session. The extents stored within the Anchor Volume Descriptor Pointer direct the DVD player to the new Main and Reserve Volume Descriptor Sequences written within each newly recorded session. A DVD player that is multisession compatible will recognize the presence of additional sessions and use the Anchor Volume Descriptor Pointer in the last recorded session to access the most recent Main and Reserve Volume Descriptor Sequences. This enables the drive to access all the information on the disc. A DVD player that is not multisession compatible will not recognize the presence of additional sessions and use the Anchor Volume Descriptor Pointer in the first recorded session to access the original Main and Reserve Volume Descriptor Sequences. This will limit the drive to access only the information in the first track of the first session on the disc.

The inability of a large portion of the installed base of DVD players to recognize and correctly access all the information on a DVD disc recorded in multiple recording events limits the utility of applications that rely on this manner of recording.

### SUMMARY OF THE INVENTION

It is therefore an object of the present invention to provide a structure of a recordable DVD disc that permits a second recording event to be recorded and accessed by DVD video players that do not recognize multisession media.

It is a further object of the present invention to provide a recordable DVD disc structure that is particularly beneficial for applications in which the first recording event is generic for many users and the second recording event is customized to an individual user.

These objects are achieved by a recordable DVD disc, comprising:

a) a recorded first track or session; and

b) a Root directory in the first track or session having a VIDEO_TS directory File Identifier Descriptor containing an Information Control Block with an Extent Location having a value that refers to an extent outside the first track or session.

The UDF specification for multisession recordable DVD discs defines a structure that limits access of a DVD player that is not multisession capable to the first track of the first session on the disc. The present invention provides a structure that enables a DVD player that is not multisession capable to access DVD video information recorded in two separate recording events.

### BRIEF DESCRIPTION OF THE DRAWINGS

FIG. 1 is a diagram of a DVD recordable disc bearing a first session;

FIG. 2 is a diagram of a DVD recordable disc bearing a first session and a second session;

FIG. 3 is a flow chart of a segment of a DVD player's operation; and

FIG. 4 is a depiction of the use of the Main Volume Descriptor Sequence Extent in a standard recordable DVD disc structure.

### DETAILED DESCRIPTION OF THE INVENTION

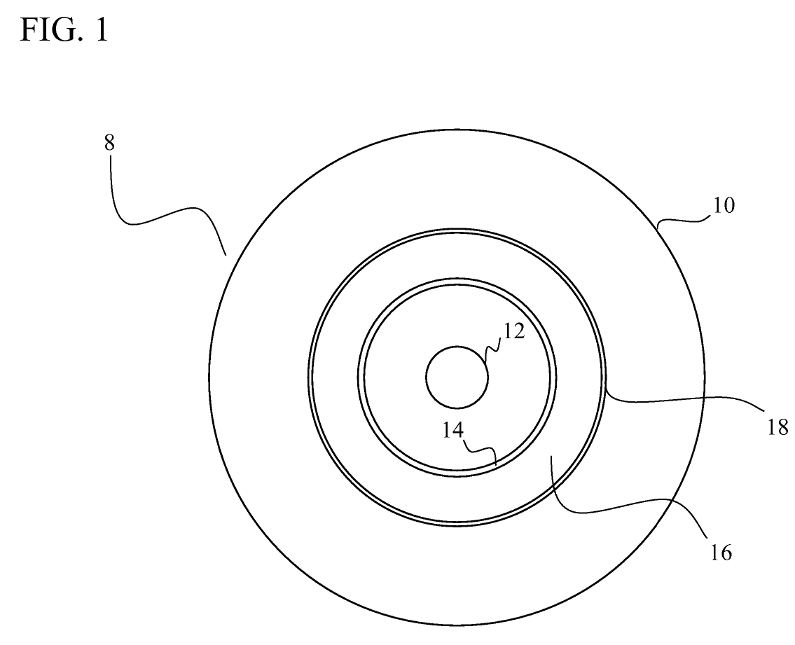

A recordable DVD disc 8 holds data in a physical area called a session. Each session includes three zones: a lead-in zone, a data zone and a lead-out zone. The data zone consists of one or more recorded tracks. The disc 8 with a single recorded session is represented graphically in FIG. 1. Between the disc outer diameter 10 and the disc center hole 12, the disc 8 bears a single recorded session. A lead-in zone 14 of the first session is recorded at an inner diameter defined by the recordable DVD specification. Immediately following this lead-in zone 14 is a data zone 16 of the first session. The size of the data zone 16 is directly related to the amount of data stored in the first session. Immediately following this data zone 16 is a lead-out zone 18 of the first session.

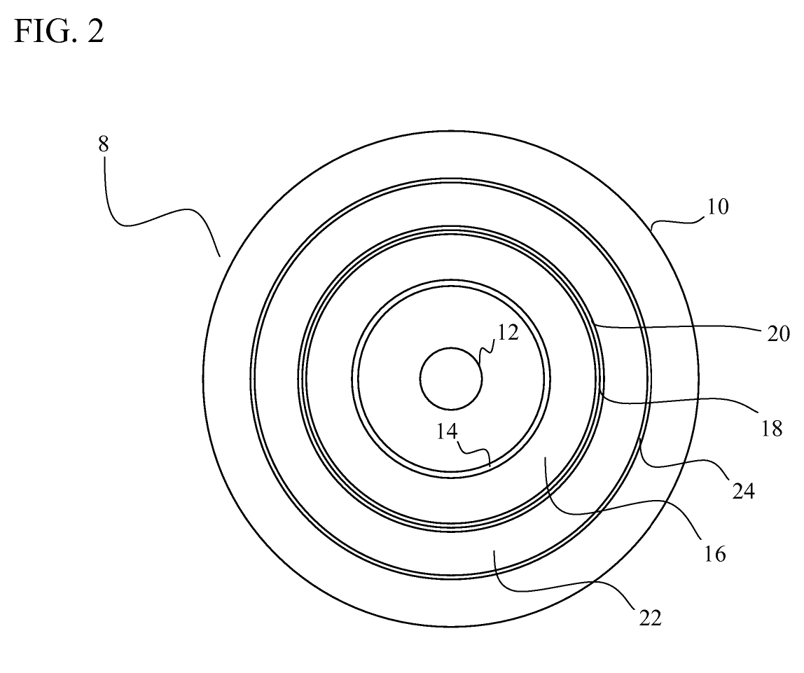

A recordable DVD disc 8 with a first recorded session and a second recorded session is represented graphically in FIG. 2. In addition to the features of a single session disc 8 shown in FIG. 1, a disc 8 with two sessions has three additional zones. A lead-in zone of the second session 20 is recorded immediately following the lead-out zone of the first session 18. Immediately following the lead-in zone of the second session 20 is a data zone 22 of the second session. The size of the data zone 22 is directly related to the amount of data stored in the second session. Immediately following this data zone 22 is a lead-out zone 24 of the second session.

The information as to whether a recorded DVD disc is single session or multisession is stored outside the data zones of the disc 8 as is well known in the disc making art. If a DVD player is multisession capable, it must read the session information before it begins to read the user data from the disc 8. The session information includes the location and length of each session on the disc 8. The DVD player needs this session information because as each new session is recorded, the structure that contains the current file and directory information is updated and recorded anew in the new session. The structure that contains file and directory information for the current content of the disc 8 is stored in the last recorded session. Once the number and location of the last session is known, the DVD player accesses that session and begins to read information from the user data area of the session. If a DVD player is not multisession capable, then it accesses the first track of the first session regardless of the number of sessions recorded on the disc.

A series of procedures is presented in UDF 1.02 for how to read a UDF disc. If a DVD player follows this series, then it must execute a sequence of operations which are summarized in TABLE 1. This sequence of operations occurs after the DVD player has recognized that a new DVD disc 8 has been mounted, has completed the necessary electromechanical operations to provide focus and tracking, and has accessed a session on the DVD disc 8.

TABLE 1

| | at Logical Sector | | |
|---|---|---|---|
| operation | Number (LSN) | extract | from |
| 1 | 256, N or N-256 | Main Volume Descriptor | Anchor Volume |
| | | Sequence LSN | Descriptor Pointer |
| | | (MVDS LSN) | |
| 2 | MVDS LSN + 2 | Partition Starting | Partition Descriptor |
| | | Location LSN | |
| | | (PSL LSN) | |
| 3 | MVDS LSN + 3 | File Set Directory | Logical Volume |
| | | location | Descriptor |
| | | (FSD LOC) | |
| 4 | PSL LSN + FSD | Root directory File Entry | File Set Directory |
| | LOC | location | |
| | | (RDFE LOC) | |
| 5 | PSL LSN + RDFE LOC | Root directory location | Root |
| | | (RD LOC) | directory File Entry |
| 6 | PSL LSN + RD | VIDEO_TS directory | Root |
| | LOC | File Entry location | directory |
| | | (VDFE LOC) | |
| 7 | PSL LSN + VDFE | VIDEO_TS directory | VIDEO_TS |
| | LOC | location | directory File Entry |
| | | (VD LOC) | |
| 8 | PSL LSN + VD | VIDEO_TS.IFO File | VIDEO_TS |
| | LOC | Entry location | directory |
| | | (V.IFE LOC) | |
| 9 | PSL LSN + V.IFE | VIDEO_TS.IFO File | VIDEO_TS.IFO file |
| | LOC | location | File Entry |
| | | (V.I LOC) | |
| 10 | PSL LSN + V.I | DVD video content | VIDEO_TS.IFO file |
| | LOC | | |

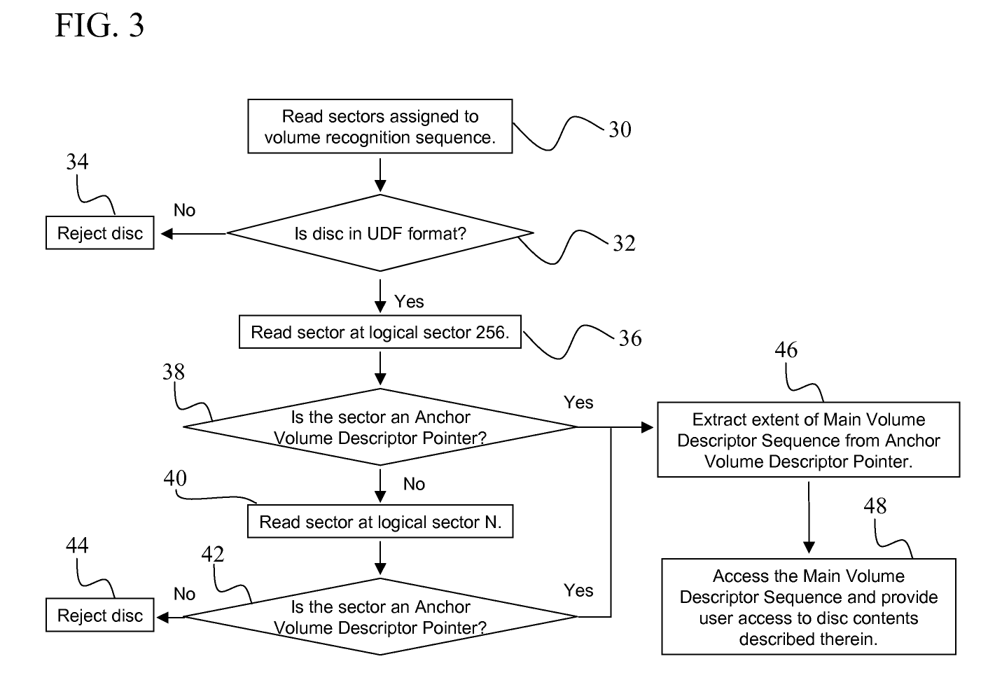

The first operation of the sequence is to determine if the disc 8 is recorded in accordance with the UDF specification. This operation is represented in FIG. 3 which is a flow chart of a segment of a DVD player's operation. In order to make the determination, the DVD player reads an area (process block 30) of the disc 8 that must contain very specific information. In particular, the disc 8 must have a sequence of data sectors of pre-defined content recorded sequentially in a specific location on the disc 8. This sequence includes the UDF volume recognition sequence. The DVD player determines whether the disc is in UDF format (process block 32). If the volume recognition sequence is not found, the disc 8 is rejected (process block 34) as being non-compliant with the UDF specification. If the volume recognition sequence is found, then the drive continues with the next operation in the segment.

The second operation has the purpose of locating the Main Volume Descriptor Sequence. The value of the extent of the Main Volume Descriptor Sequence is found within the Anchor Volume Descriptor Pointer. According to the UDF specification, the Anchor Volume Descriptor Pointer shall be recorded in at least two of the following three locations on the media:
Logical sector 256
Logical sector (N−256)
Logical sector N
   where N is the largest logical sector number in the volume space. The drive now attempts to locate the Anchor Volume Descriptor Pointer. The order in which it interrogates the possible location is arbitrary, however version 1.02 of the UDF specification directs the DVD player to logical sector 256, so it is assumed in FIG. 3 that the DVD player tries that location first. The drive performs a read operation (process block 36) at logical sector 256. It then makes a decision (decision block 38) based on the contents of sector 256 as to whether the sector contains the Anchor Volume Descriptor Pointer. If the Anchor Volume Descriptor Pointer is not in logical sector 256, the DVD player then searches one of the other possible locations. FIG. 3 assumes the DVD player tries logical sector N next. The drive performs a read operation (process block 40) at logical sector N. It then makes a decision (decision block 42) based on the contents of sector N as to whether the sector contains the Anchor Volume Descriptor Pointer. If the Anchor Volume Descriptor Pointer is not found in the second location, the disc 8 is rejected (process block 44) since it does not comply with the UDF specification. If the DVD player does locate an Anchor Volume Descriptor Pointer, it then performs the extraction (process block 46) of the extent of Main Volume Descriptor Sequence. This permits the DVD player to access (process block 48) the Main Volume Descriptor Sequence within the session.

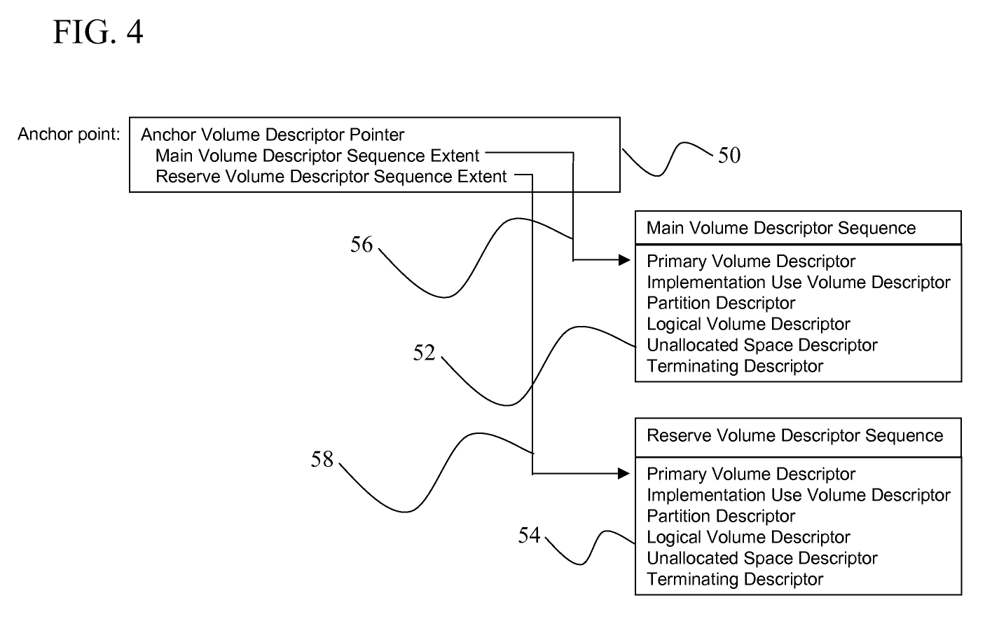

The third operation has the purpose of locating the File Set Descriptor. Referring to FIG. 4, a more detailed chart is provided of an Anchor Volume Descriptor Pointer 50, a Main Volume Descriptor Sequence 52, and a Reserve Volume Descriptor Sequence 54. The Main Volume Descriptor Sequence Extent in the Anchor Volume Descriptor Pointer 50 provides the destination address for the access path to the Main Volume Descriptor Sequence 56. The Reserve Volume Descriptor Sequence Extent in the Anchor Volume Descriptor Pointer 50 provides the destination address for the access path to the Reserve Volume Descriptor Sequence 58. As FIG. 4 indicates, the contents of the Main Volume Descriptor Sequence 52 and the Reserve Volume Descriptor Sequence 54 are identical. The Main Volume Descriptor Sequence contains these key descriptors for the disc 8: the Primary Volume Descriptor, the Implementation Use Volume Descriptor, the Partition Descriptor, the Logical Volume Descriptor, the Unallocated Space Descriptor and the Terminating Descriptor. In this operation, the DVD player retrieves the logical sector number of the Partition Starting Location (PSL LSN) from the Partition Descriptor and the File Set Directory location (FSD LOC) from the Logical Volume Descriptor. The logical sector number at which the File Set Descriptor is located is equal to the sum of the logical sector number of the Partition Starting Location and the File Set Directory location (PSL LSN+FSD LOC).

The fourth operation has the purpose of locating the Root directory File Entry. The DVD player retrieves the Root directory File Entry location from the File Set Directory. The logical sector number at which the Root directory File Entry is located is equal to the sum of the logical sector number of the Partition Starting Location and the Root directory File Entry location.

The fifth operation has the purpose of locating the Root directory. The DVD player retrieves the Root directory location from the Root directory File Entry. The logical sector number at which the Root directory is located is equal to the sum of the logical sector number of the Partition Starting Location and the Root directory location.

The sixth operation has the purpose of locating the VIDEO_TS directory File Entry. The DVD player retrieves the VIDEO_TS directory File Entry location from the Information Control Block in the VIDEO_TS directory File Identifier Descriptor located in the Root directory. The logical sector number at which the VIDEO_TS directory File Entry is located is equal to the sum of the logical sector number of the Partition Starting Location and the VIDEO_TS directory File Entry location.

The seventh operation has the purpose of locating the VIDEO_TS directory. The DVD player retrieves the VIDEO_TS directory location from the VIDEO_TS directory File Entry. The logical sector number at which the VIDEO_TS directory is located is equal to the sum of the logical sector number of the Partition Starting Location and the VIDEO_TS directory location.

The eighth operation has the purpose of locating the VIDEO_TS.IFO File Entry. The DVD player retrieves the VIDEO_TS.IFO File Entry location from the Information Control Block in the VIDEO_TS.IFO File Identifier Descriptor located in the VIDEO_TS directory. The logical sector number at which the VIDEO_TS.IFO File Entry is located is equal to the sum of the logical sector number of the Partition Starting Location and the VIDEO_TS.IFO File Entry location.

The ninth operation has the purpose of locating the VIDEO_TS.IFO file. The DVD player retrieves the VIDEO_TS.IFO file location from the VIDEO_TS.IFO File Entry. The logical sector number at which the VIDEO_TS.IFO file is located is equal to the sum of the logical sector number of the Partition Starting Location and the VIDEO_TS.IFO file location.

The tenth operation has the purpose of playing the content on the disc. Once the VIDEO_TS.IFO file is located, the other files required by a DVD video player to present the DVD video information on the disc may be accessed as needed.

If a DVD player is not multisession compatible and is dealing with a single session disc, then the process described above is carried out in the first track of the first (and only) session, and all the structure needed to access the user data and directories on the disc will be correctly read. If a DVD player is not multisession compatible and is dealing with a multisession disc, then the process described above is still carried out in the first track of the first session, and the structure found will only permit access to the user data and directories recorded in the first recording event which are found in the first track of the first session. Any DVD video content subsequently recorded is inaccessible.

In order to permit all the data on a disc recorded in two recording events to be available to a DVD player that is not compatible with a multisession disc, the present invention enables the DVD player to access the last structure recorded on the disc. By altering the value of the Extent Location within the Information Control Block in the VIDEO_TS directory File Identifier Descriptor located in the Root directory in the first track of the first session such that it refers to an extent outside the first track of the first session, a DVD player that is not compatible with a multisession disc will be led to access DVD video information recorded after the first recording event.

In order for the access of the DVD video information in the second recording event to be successful, the altered value of the Extent Location within the Information Control Block in the VIDEO_TS directory File Identifier Descriptor located in the Root directory of the first track of the first session must direct the DVD player to the VIDEO_TS directory File Entry recorded during the subsequent recording event. Since, in general, the first track of the first session of the disc will be written without foreknowledge of the detailed contents of the second recording event, the problem must be addressed in reverse. That is, the VIDEO_TS directory File Entry recorded during the second recording event must be recorded at the logical sector number to which the DVD player will be directed by the altered value of the Extent Location within the Information Control Block in the VIDEO_TS directory File Identifier Descriptor located in the Root directory of the first track of the first session.

This may be accomplished by reading the value of the Extent Location within the Information Control Block in the VIDEO_TS directory File Identifier Descriptor located in the Root directory of the first track of the first session prior to performing the second recording event and modifying the UDF structure creation software so the VIDEO_TS directory File Entry is appropriately positioned, but this is a rather complicated task. A simpler approach would be to run the UDF structure creation software unaltered when creating the second recording event structure, then to copy the VIDEO_TS directory File Entry to the logical sector number to which the DVD player will be directed by the altered value of the Extent Location within the Information Control Block in the VIDEO_TS directory File Identifier Descriptor located in the Root directory of the first track of the first session. This latter approach requires that the logical sector number chosen for the copy of the VIDEO_TS directory File Entry is unused by any other file or structure and is accessible within the second recording event. Fortunately, there are a number of locations that meet these requirements. For example, in the first 256 logical sectors of a UDF recording, less than half are allocated to UDF Descriptors. The remaining sectors are unallocated and not reserved. In particular, logical sector numbers 80 through 255 inclusive are not generally allocated to UDF descriptors, making this region a prime candidate for the location of a copy of the VIDEO_TS directory File Entry.

In addition to the VIDEO_TS directory File Entry, one may choose to place copies of other structures in this region as well. For example, one could place a copy of the VIDEO_TS directory immediately after the VIDEO_TS directory File Entry. This would permit the DVD player to rapidly access the directory. It would also provide compatibility with DVD players that expect the VIDEO_TS directory to follow immediately after the VIDEO_TS directory File Entry. If it were desired for the copy of the VIDEO_TS directory FILE Entry to direct the DVD player to a copy of the VIDEO_TS directory, then the location of the VIDEO_TS directory within the VIDEO_TS directory FILE Entry would need to be appropriately modified.

A general method for creating a recordable DVD video disc recorded in two recording events that is compatible with DVD video players that do not recognize multisession DVD media is outlined below:

1) Prepare a binary image of a first track for recording on a recordable DVD disc including both binary data and a file system compatible with the Universal Disk Format Specification. (A binary image contains the actual data that should exist on the DVD disc.) Alternatively the first track can be recorded in standard fashion and subsequently the binary image generated by reading the first track from the disc as a binary image.

2) Based on the size of the binary image of the first track, compute what the starting sector of the next recording event would be. This value depends on the mode in which the disc will be written, i.e. track-at-once or session-at-once mode. Alternatively, a second recording can be recorded after the first recording in the desired mode, and the starting sector of the second recording read from the disc using appropriate software tools.

3) Modify the binary image of the first track of the first session by changing the value of the Extent Location within the Information Control Block in the VIDEO_TS directory File Identifier Descriptor located in the Root directory of the first track of the first session. The value of the Extent Location must refer to an extent outside the first track of the first session. If the location that the VIDEO_TS directory File Entry will occupy in the second recording is known, then the value of the Extent Location within the Information Control Block in the VIDEO_TS directory File Identifier Descriptor located in the Root directory of the first track of the first session is set to this location. If the location that the VIDEO_TS directory File Entry will occupy in the second recording is not known, then the value of the Extent Location within the Information Control Block in the VIDEO_TS directory File Identifier Descriptor located in the Root directory of the first track of the first session is set to a location in the second recording that is unallocated and can be used by the second recording authoring software to locate a copy of the VIDEO_TS directory File Entry. In the latter case, a preferred location would be within the first 256 logical sectors of the second recording and preferably within logical sector numbers 80 and 255 inclusive.

4) Record the modified binary image of the first track of the first session in either track-at-once or session-at-once mode in accordance with the mode used in step 2).

5) Use authoring software for creating the second recording that reads the value of the Extent Location within the Information Control Block in the VIDEO_TS directory File Identifier Descriptor located in the Root directory of the first track of the first session and creates a copy of the VIDEO_TS directory File Entry at that location in the binary image of the second recording.

6) Perform the second recording.

When a disc created as outlined above is played by a DVD player that does not recognize multisession DVD media, the DVD player will attempt to locate the VIDEO_TS directory File Entry by reading the value of the Extent Location within the Information Control Block in the VIDEO_TS directory File Identifier Descriptor located in the Root directory of the first track of the first session. This value will lead the DVD player to the location of the copy of the second recording's VIDEO_TS directory File Entry, and then on to the DVD video information stored within the second recording.

The invention has been described in detail with particular reference to certain preferred embodiments thereof, but it will be understood that variations and modifications can be effected within the spirit and scope of the invention.

### PARTS LIST

8 disc
10 disc outer diameter
12 disc centering hole
14 first session lead-in zone
16 first session data zone
18 first session lead-out zone
20 second session lead-in zone
22 second session data zone
24 second session lead-out zone
30 process block
32 decision block
34 process block
36 process block
38 decision block
40 process block
42 decision block
44 process block
46 process block
48 process block
50 Anchor Volume Descriptor Pointer
52 Main Volume Descriptor Sequence
54 Reserve Volume Descriptor Sequence
56 access path to the Main Volume Descriptor Sequence
58 access path to the Reserve Volume Descriptor Sequence

1. A recordable DVD disc, comprising:
a) a recorded first session; and
b) a Root directory in the first session having a VIDEO_TS directory File Identifier Descriptor containing an Information Control Block with an Extent Location having a value that refers to an extent outside the first session.

2. The recordable DVD disc of claim 1 wherein the value of the Extent Location within the Information Control Block in the VIDEO_TS directory File Identifier Descriptor located in the Root directory of the first session refers to an extent located within the first 256 logical sectors of a second session.

3. The recordable DVD disc of claim 1 wherein the value of the Extent Location within the Information Control Block in the VIDEO_TS directory File Identifier Descriptor located in the Root directory of the first session refers to an extent located within logical sector numbers 80 through 255 inclusive of a second session.

4. The recordable DVD disc of claim 2 wherein a copy of the VIDEO_TS directory File Entry of the second session is located at the Extent Location within the Information Control Block in the VIDEO_TS directory File Identifier Descriptor located in the Root directory of the first session.

5. The recordable DVD disc of claim 3 wherein a copy of the VIDEO_TS directory File Entry of the second session is located at the Extent Location within the Information Control Block in the VIDEO_TS directory File Identifier Descriptor located in the Root directory of the first session.

6. The recordable DVD disc of claim 4 wherein a copy of the VIDEO_TS directory of the second session is located immediately following the copy of the VIDEO_TS directory File Entry of the second session located at the Extent Location within the Information Control Block in the VIDEO_TS directory File Identifier Descriptor located in the Root directory of the first session.

7. The recordable DVD disc of claim 5 wherein a copy of the VIDEO_TS directory of the second session is located immediately following the copy of the VIDEO_TS directory File Entry of the second session located at the Extent Location within the Information Control Block in the VIDEO_TS directory File Identifier Descriptor located in the Root directory of the first session.

8. A recordable DVD disc, comprising:
a) a recorded first track; and
b) a Root directory in the first track having a VIDEO_TS directory File Identifier Descriptor containing an Information Control Block with an Extent Location having a value that refers to an extent outside the first track.

9. The recordable DVD disc of claim 8 wherein the value of the Extent Location within the Information Control Block in the VIDEO_TS directory File Identifier Descriptor located in the Root directory of the first track refers to an extent located within the first 256 logical sectors of a second track.

10. The recordable DVD disc of claim 8 wherein the value of the Extent Location within the Information Control Block in the VIDEO_TS directory File Identifier Descriptor located in the Root directory of the first track refers to an extent located within logical sector numbers 80 through 255 inclusive of a second track.

11. The recordable DVD disc of claim 9 wherein a copy of the VIDEO_TS directory File Entry of the second track is located at the Extent Location within the Information Control Block in the VIDEO_TS directory File Identifier Descriptor located in the Root directory of the first track.

12. The recordable DVD disc of claim 10 wherein a copy of the VIDEO_TS directory File Entry of the second track is located at the Extent Location within the Information Control Block in the VIDEO_TS directory File Identifier Descriptor located in the Root directory of the first track.

13. The recordable DVD disc of claim 11 wherein a copy of the VIDEO_TS directory of the second track is located immediately following the copy of the VIDEO_TS directory File Entry of the second track located at the Extent Location within the Information Control Block in the VIDEO_TS directory File Identifier Descriptor located in the Root directory of the first track.

14. The recordable DVD disc of claim 12 wherein a copy of the VIDEO_TS directory of the second track is located immediately following the copy of the VIDEO_TS directory File Entry of the second track located at the Extent Location within the Information Control Block in the VIDEO_TS directory File Identifier Descriptor located in the Root directory of the first track.

15. The recordable DVD disc of claim 8 wherein the first track and the extent outside the first track are in the same session.

16. The recordable DVD disc of claim 8 wherein the first track and the extent outside the first track are in different sessions.
